(19) United States
(12) Patent Application Publication
(10) Pub. No.: US 2006/0176891 A1
(43) Pub. Date: Aug. 10, 2006

(54) Method for controlling data interchange

(75) Inventors: Thomas Jachmann, Wendelstein (DE); Uwe Ruckl, Berlin (DE)

Correspondence Address: LERNER GREENBERG STEMER LLP, P O BOX 2480, HOLLYWOOD, FL, 33022-2480, US

(73) Assignee: Siemens AG

(21) Appl. No.: 10/565,413

(22) PCT Filed: Jun. 23, 2004
(86) PCT No.: PCT/DE04/01341

§ 371 Date: Jan. 23, 2006

(30) Foreign Application Priority Data
Jul. 22, 2003 (DE) 10333888.8

(51) Int. Cl. H04L 12/56

(52) U.S. Cl. 370/412

(57) ABSTRACT

A method for exchanging data between a communications unit and a data source of a control system, during which a runtime system comprised of hardware components and software components transfers data between the data source and a communications unit, and a processing chain controls and/or monitors the exchange of data. The process can be modified easily and without interrupting the runtime system. To this end, the invention provides that the processing chain is composed of processing routines, which each have a uniform input interface, whereby the processing routines are called up in succession, and the data of a called up processing routine are fed to the input interface of an immediately subsequent processing routine. In addition, the runtime system manages a dynamic storage area and accesses this storage area in order to establish the sequence with which the processing routines are called up.

The invention relates to a method for interchanging data between a communication unit and a data source, in which a runtime system comprising hardware components and software components transmits data between the data source and a communication unit and a processing sequence controls and/or monitors the interchange of the data.

Such a method is already known from the accepted prior art. Thus, by way of example, centralized control systems are normally used for monitoring and controlling large-capacity networks such as power supply mains, water supply lines and rail systems. Larger blocks of flats may also be equipped with centralized control systems for controlling air-conditioning systems, elevators, lighting systems or the like. The parts required for controlling such divided systems are therefore normally likewise decentralized or in other words set up so that they are distributed over a large area and are connected to one another by means of a runtime system which has at least one expedient communication network and programmable computer units on which expedient runtime programs allow information to be interchanged. Generally, hardware interfaces are used for data interchange between the parts which deliver process values, for example, on the one hand, and the locally installed software components of the runtime system, on the other hand. For the purpose of requesting these process values, a communication unit is provided, such as an input computer connected to the hardware interface via the communication network. The processing sequence is used to control the data interchange between the parts and the communication unit.

Thus, the processing sequence checks the user name entered for the purpose of logging into the runtime system, for example, and the associated password for authorization to receive the process values from the selected part. This allows sensitive process values to be shielded from being known by particular users. In addition, processing sequences are known which are equipped with what is known as error analysis, which the processing sequence uses to indicate the presence of incompatibilities among parts which are used or among software modules and possibly to demonstrate solutions for eliminating such defects.

The previously known method has the attached drawback that the processing sequence is monolithically embedded in a source code of the runtime programs running during normal operation of the centralized control system. This means that such processing steps for controlling data interchange can be changed only by altering the source code of the software components. Following the change, the entire runtime programs therefore need to be recompiled and installed on the hardware components.

It is an object of the invention to provide a method of the type mentioned at the outset which can easily be altered or extended without interrupting the runtime system.

The invention achieves this object in that the processing sequence is made up of processing routines which each have a standard input interface, with the processing routines being called in succession and the data in a called processing routine being supplied to the input interface of a processing routine which is immediately downstream of the latter, and in that the runtime system manages a dynamic memory area and accesses said memory area in order to stipulate the order in which the processing routines are called.

In line with the invention, the control and monitoring of the interchange of the data is of flexible design and can also be altered as desired after the runtime system has been started up. To this end, the data, for example a request which a user has input for process values from the part, pass through processing routines in order. The processing routines monitor the requests, for example by storing them in access files, or control them by adding further data, for example. In this case, each processing routine has an input interface which is defined by software and which is identical for all processing routines. For the purpose of interchange, the data processed by the respective processing routine are then supplied to the input interface of the processing routine which is immediately downstream. In other words, each processing routine is compatible or interchangeable with the other processing routines on account of its standard input interface. The processing routines can therefore be called in any desired order without the data interchange between the processing routines causing error messages or more serious damage.

In line with the invention, the runtime system comprises runtime programs and hardware components which are compiled from computers, physical centralized control networks, interfaces or the like. The physical centralized control networks also comprise wireless network connections. The runtime programs can be distributed over the hardware components.

To be able to alter the order of the processing routines in line with the respective requirements even during processing of the software components in the runtime system, the software of the runtime system manages a dynamic memory area whose memory size can thus also be altered during operation of the runtime system. To stipulate the order in which the processing routines are called, the runtime system accesses processing data stored in the memory area. The processing data may be a configuration file, for example, in which the addresses of the desired processing routines are listed line by line, with the runtime system executing the lines in succession and in so doing calling the processing routine listed in each line by means of its address. The runtime system executes the lines of the configuration data sequentially until the end of the configuration file is indicated to the runtime system.

The dynamic management of the memory area allows any number of lines to be provided and hence any number of processing routines to be called. This may advantageously be used right at the time at which the software components of the runtime system are developed, by virtue of error diagnosis routines or in other words error analysis routines being incorporated into the processing sequence. Since the runtime programs are executed largely without error, the number of error diagnosis routines can be greatly reduced in order to increase the speed of data interchange in this way or in other words to improve the “performance” of the runtime system. This in no way requires the software components of the runtime system to be changed. By way of example, the invention merely requires reparameterization to be performed. This also applies to the search for errors following implementation of the runtime system, said errors being able to be restricted by the later addition of error analysis routines to the processing sequence.

Both hardware components and software components are suitable as a data source. Thus, the data source may be part of a centralized control system, for example, with the runtime system being connected to the part by means of expedient interfaces. As a departure from this, the data source may also be a software module, for example a software driver or else a database containing information data corresponding to a particular state or to the version of a system, however.

In line with the invention, the dynamically managed memory area is a memory area in the “RAM store” of a computer.

Advantageously, the data are provided with a user identifier, and at least one authorization routine checks the user identifier for a match with entries in prescribed user lists and terminates the forwarding of the data if it establishes that there is no match between the user identifier and the user lists. In this way, the user is shown only process values which he is authorized to receive. Sensitive data can thus be displayed on a user-specific basis. The user identifier does not necessarily have to have an individualizing character within the context of the invention. Thus, it is entirely possible for the user identifier to have a role-specific character such that the user is assigned as such to a particular group or role. It is thus possible for the user to be characterized as a developer or parameter-setter by the user identifier, for example.

It is also expedient for the data to be provided with a data-source-specific source data identifier, and for one or more of the processing routines to control the interchange of the data on the basis of the source data identifier. The source data identifier, like the user identifier, is produced by adding “metadata” to the data which are interchanged.

In line with one further development which is advantageous in this regard, at least one processing routine is a buffer-store routine in which buffer-store data are buffer-stored with a respective buffer-store data identifier, and if the source data identifier matches one of the buffer-store data identifier then the buffer-store routine displays the buffer-store data associated with the buffer-store data identifier and terminates the interchange of the data. If the source data identifier is a part identifier, for example, it is possible, by way of example, for a request for particular process values from a centralized control system to involve the processing routine being prompted to buffer-store particular process values. By way of example, the buffer-stored process values are process values which change only slowly in comparison with the request frequency or which do not change at all, or else parameters which have been input by a third party with access authorization. Upon a fresh request, the processing routine (which is also called a buffer-store or caching routine, for example) provides the requested process value without the runtime system having accessed the relevant part. It has thus become superfluous for the runtime system to access the part, which speeds up the method.

In this connection, any other display options are conceivable which cannot be conclusively listed at this juncture. Thus, by way of example, an “enrichment routine” can convert coded data from the runtime system into user-comprehensible data. The enrichment routine also adds additional control data or in other words metadata to the data which are to be interchanged between the communication unit and the data source in order to control the display of data or the flow of data.

Advantageously, one of the processing routines is an error analysis routine which checks the data for the presence of errors. This may be any desired error analysis tool. Thus, the data can be checked, by way of example, to determine whether instead of a natural number or an integer there have been letters or the like input. However, the error analysis routine can also monitor the compatibility of protocols or hardware components of the runtime system.

Advantageously, at least one processing routine is a monitoring routine which stores the data and/or monitoring data derived from the data in a monitoring file. This monitoring file stores, by way of example, all access operations to the runtime system in a month, which means that this makes it possible to document who has accessed what data source, for example a part in a centralized control system, at what time.

In line with one preferred exemplary embodiment of the invention, the runtime system has a network server with a server program and at least one client computer with a browser program, and each browser program accesses the server program via the Internet. In this exemplary embodiment of the invention, the data interchange is made possible not just via an externally terminated centralized control communication network, for example, but rather via existing Internet connections which have already been provided physically. It goes without saying that the invention also allows, by way of example, the communication network of the centralized control system to be incorporated into a superordinate “Intranet”, which for its part can be connected to the Internet.

In line with one further development in this regard, at least one processing routine is a tracing routine which checks the path of the data in the runtime system and generates security parameters on the basis of the check. On the basis of these security parameters, it is now possible to control the display or forwarding of the data, for example. If a user of the method is connected to the runtime system via an “Intranet”, for example, fewer reservations regarding data sensitivity or integrity are normally required, since access to the Intranet by unauthorized parties is normally more difficult. In the case of local applications, security reservations can be eliminated almost completely, whereas only insensitive data or process values are displayed during access via the Internet.

Expediently, a configuration file is loaded into the dynamic memory area, the configuration file stipulating the structure and the order of the processing routines. by way of example, the configuration file is called when the runtime system is initialized. In addition, however, it is also possible for the user to initiate calling of the configuration file by the runtime system. The configuration file can also be called following implementation by the runtime system without the user, for example at particular times.

Further expedient refinements and advantages of the invention are the subject matter of the description below with reference to the figure of the drawing, in which

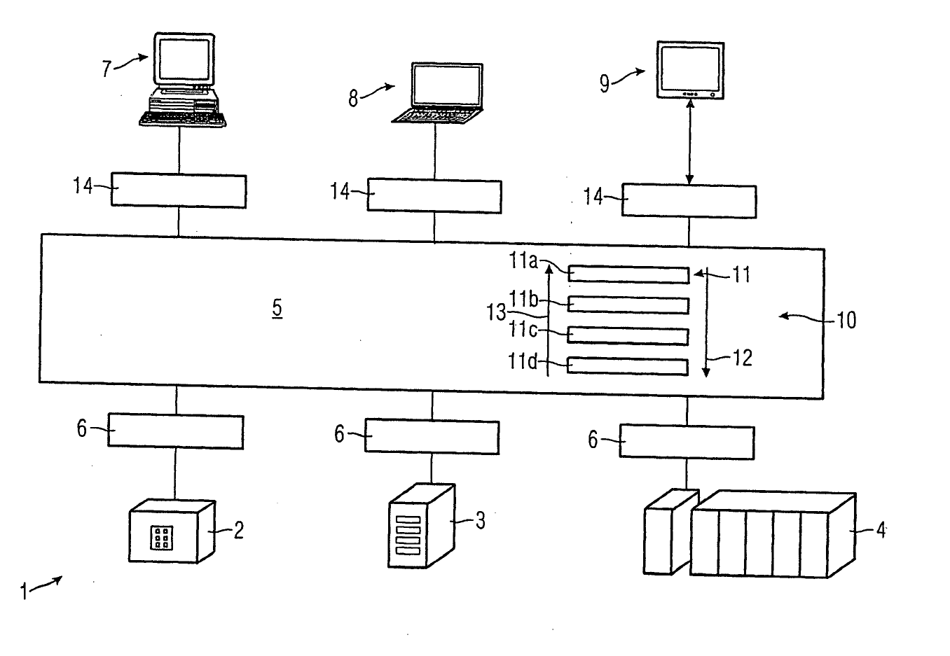

FIG. 1 shows a flowchart for schematically illustrating the inventive method.

FIG. 1 shows a flowchart to clarify the inventive method. It schematically shows a centralized control system 1 which comprises local protective devices 2 and 3 and also a central control center 4 for controlling and monitoring the protective devices 2, 3. The protective devices 2 and 3 are connected to voltage transformers (not shown in the figure) whose primary side is coupled to a system branch (likewise not shown) in a power distribution mains. The secondary-side converter current, which is proportional to the current in the system branch, is sampled by a measurement detection unit in the protective device 2 to obtain samples, and the samples are then digitized to form digital current values. The protective devices 2 or 3 can trigger expedient switches or circuit breakers which interrupt the flow of current in the system branch if, by way of example, the digital current values exceed a threshold value, for example in the case of a short circuit. In this context, the protective devices 2 or 3 are arranged in the immediate surroundings of the system branch, that is to say of the primary conductor.

The control center 4 is provided for monitoring and controlling the protective devices 2 or 3. To this end, it is connected to the protective devices 2 and 3 via an expedient communication network (not shown in the figure). To ensure secure data interchange between the protective devices 2 or 3 and the control center 4, a continually running runtime program 5 is provided which is distributed over the hardware components in the runtime system. In this case, the runtime program 5 uses hardware drivers 6 to access hardware interfaces in the parts 2, 3, 4 of the centralized control system 1. Thus, by way of example, digital current values from the protective device 2 are stored in a register in the protective device 2 and can be supplied to the control center 4 via the communication network which is not shown, the hardware drivers 6 undertaking the addressing and control of the flow of data together with the runtime program 5.

To be able to monitor the states of the parts 2, 3 or 4 of the centralized control system 1 externally, that is to say from locations which are not included in the communication network of the centralized control system 1, communication units are provided, such as a fixed-location standalone computer 7, a laptop 8 or a “PDA”, which are connected to the “Internet” via a modem port, ISDN, DSL or a wireless local area network connection. The runtime system comprises an Internet computer on which a server program in the runtime program 5 runs. The communication units use their browser programs 14 to access the server program via the lines of the Internet. A user is therefore able to request process values from the centralized control system 1 and/or to control these process values via the Internet.

To control the data interchange between the components 2, 3 and 4 of the centralized control system 1 and the communication units 7, 8 and 9, a processing sequence 10 is provided which is made up of successively running processing routines 11. To allow smooth data interchange between the processing routines 11 in any order, their software includes a respective standard output interface and also a respective standard input interface, with the data to be controlled and monitored being routed from the output interface of one of the processing routines to the input interface of the downstream, subsequently called processing routine.

To request the current value digitized by the protective device 2, a user with the PDA 9, for example, uses a wireless “Bluetooth” connection to physically connect his PDA to the Internet. The user then uses his PDA 9 to register on the runtime program 5 by specifying his user name and his password. Next, he selects the protective device 2, for example from a protective device tree which is displayed to him, and the process value which is required by the protective device 2. The runtime program 5 takes the selection on the PDA 9 as a basis for producing a part identifier as source data identifier which is specific to the protective device 2. In other words, a part address is produced on the basis of the selection by the user. In addition, a register address for selecting the desired current value is generated. The runtime program 5 also produces control data, in this case as “Read signal”, which is used to notify the addressed hardware interface that the addressed register needs to be read. Before the processing sequence 10 is processed, the data also have a user identifier added to them on the basis of the user name.

Upon a request for the digital current value from the protective device 2 to be shown, these request data are routed through the processing sequence 10 in a request direction 12. In the exemplary embodiment shown, the first processing routine is a security routine 11a which accepts the data at its input interface from the runtime program 5. The security routine 11a establishes whether the user is authorized for the data request. To this end, the security routine 11a compares the user identifier of the request data with lists embedded in the security routine and forwards the data to the output interface of the authorization routine 11a only if the user identifier matches an entry in this list.

From there, the data are routed to the input interface of a buffer-store routine 11b. The buffer-store routine 11b checks whether the requested process values are particular process parameters which have been stipulated in software when the buffer-store routine was created. Such process values are process values which change only slowly in comparison with the time interval between two successive requests or which do not change at all, for example. If the buffer-store routine 11b establishes that such a particular process parameter stored in it from a previous request is being requested, it provides this process parameter which has already been requested previously and terminates the further request. Otherwise, it forwards the data via its output interface directly to a user routine 11c. The user routine 11c forwards the data in the request direction 12 to a “tracing routine” 11d without processing the data, and the runtime program 5 adopts the processed data again from the tracing routine. In the request direction 12, the data are not processed by the tracing routine 11d either.

The runtime program 5 then uses the associated hardware interface 6 to access the process values of the selected part 2 and adds a current value to the data as process value. Next, the runtime program 5 transfers the data with the current value to the input interface of the tracing routine 11d. The data are now routed through the processing sequence 10 in direction 13. The tracing routine 11d uses the request data to check the location from which the user is accessing the runtime program 5. If the user has registered on the runtime program 5 using a local area network which can be accessed only with great difficulty externally, for example, the display options of the runtime program are not limited by tracing routine 11d. In the present example, the user of the PDA 9 has registered on the runtime program 5 via the Internet, however, which means that for reasons of security only restricted display of information is intended. To this end, the tracing routine 11d adds further security data to the requested current value and to the rest of the request data, said security data producing a particular display format for the runtime program 5.

Next, the data are routed to the user routine 11c, which adds display parameters to the data, depending on the role of the user. In the exemplary embodiment shown, the user is a parameter-setter for whom highly specialized display data, for example for detecting errors, might also be useful, whereas they would be confusing to the normal user. The user routine 11c therefore adds such display parameters to the request data as prompt the runtime program 5 to display all the data.

From the user routine 11c, the data are then routed to the buffer-store routine 11b. In the arrow direction 13 shown, the buffer-store routine 11b and the security routine 11a do not process the data. The security routine 11a finally passes them to the runtime program 5, which displays the data on the PDA 9 in accordance with the processing parameters.

1-9. (canceled)

10. A method for data interchange, the method which comprises:
providing a communication unit, a data source, and a runtime system between the communication unit and the data source, the runtime system including hardware components and software components for transmitting data between the data source and the communication unit;
controlling and/or monitoring a data exchange between the communication unit and the data source with a processing sequence;
the processing sequence comprising processing routines each having a standard input interface;
calling the processing routines in succession and supplying data in a called processing routine to the input interface of an immediately adjoining processing routine; and
managing, with the runtime system, a dynamic memory area and accessing the memory area to stipulate an order wherein the processing routines are called.

11. The method according to claim 10, wherein the data source is a part in a distributed system.

12. The method according to claim 10, which comprises providing the data with a user identifier, and checking, with at least one authorization routine, the user identifier for a match with entries in prescribed user lists, and terminating data forwarding if no match is established between the user identifier and an entry in the user lists.

13. The method according to claim 10, which comprises providing the data with a data-source-specific source data identifier, and controlling processing of the data by the processing routine on the basis of the source data identifier.

14. The method according to claim 13, which comprises controlling the processing of the data on the basis of the source data identifier with one or more of the processing routines.

15. The method according to claim 13, wherein at least one of the processing routines is a buffer-store routine for buffer-storing data with a respective buffer-store data identifier, and if the source data identifier matches a given buffer-store data identifier, the buffer-store routine displays the buffer-store data associated with the buffer-store data identifier and terminates the interchange of the data.

16. The method according to claim 10, wherein at least one of the processing routines is an error analysis routine configured to check the data for a presence of predetermined errors.

17. The method according to claim 10, wherein at least one of the processing routines is a monitoring routine configured to store the data and/or monitoring data derived from the data in a monitoring file.

18. The method according to claim 10, wherein the runtime system has a network server with a server program and at least one client computer with a browser program, and the method comprises accessing the server program with each browser program through the Internet.

19. The method according to claim 10, wherein at least one of the processing routines is a tracing routine configured to check a path of the data in the runtime system and to generate security parameters based on the check.

20. The method according to claim 10, which comprises loading a configuration file into a dynamic memory area, the configuration file stipulating a structure and an order of the processing routines.
